(19) United States
(12) Patent Application Publication
(10) Pub. No.: US 2026/0066353 A1
(43) Pub. Date: Mar. 5, 2026

(54) METHOD FOR MANUFACTURING SECONDARY BATTERY, SECONDARY BATTERY, ENERGY STORAGE SYSTEM, AND ELECTRIC DEVICE

(71) Applicant: Zhejiang Jinko Energy Storage Co., Ltd., Haining (CN)

(72) Inventors: Yutao SHI, Haining (CN); Yujun MA, Haining (CN); Yang LIU, Haining (CN)

(21) Appl. No.: 19/377,777

(22) Filed: Nov. 3, 2025

(30) Foreign Application Priority Data
Jun. 20, 2025 (CN) 202510839568.0

(51) Int. Cl. H01M 10/058; B23K 26/352; B23K 101/38; H01M 4/02; H01M 4/04

(52) U.S. Cl. CPC H01M 10/058; B23K 26/355; H01M 4/0435; H01M 4/0471; B23K 2101/38; H01M 2004/021; H01M 2004/027; H01M 2004/028

(57) ABSTRACT

A method for manufacturing a secondary battery, a secondary battery manufactured by the method, an energy storage system, and an electric device are provided. The method includes: providing an electrode sheet; measuring an actual porosity of the electrode sheet; determining whether the electrode sheet is qualified based on the actual porosity of the electrode sheet; in response to the electrode sheet being determined to qualified, forming the secondary battery using the electrode sheet; in response to the electrode sheet being determined to be unqualified, performing laser processing to form laser-formed pores on the electrode sheet, and repeating the measuring operation and the determining operation until the electrode sheet is qualified. In this way, the uniformity of electrode sheet porosity is improved, the wettability of the electrode sheet is enhanced, and the electrical performance of the secondary battery is improved.

### CROSS REFERENCE TO RELATED APPLICATIONS

This application claims the benefit of priority under the Paris Convention to Chinese Patent Application No. 202510839568.0, filed on Jun. 20, 2025, which is incorporated herein by reference in its entirety.

### TECHNICAL FIELD

The present application relates to the technical field of batteries, and in particular to a method for manufacturing a secondary battery, a secondary battery, an energy storage system, and an electric device.

### BACKGROUND

In the manufacturing process of a secondary battery, the manufacturing of an electrode sheet is one of the key operations. The wettability of the electrode sheet plays an important role in improving the electrical performance of the secondary battery. Currently, the manufacturing process for an electrode sheet of a secondary battery mainly includes operations such as electrode sheet loading, unwinding and conveying, electrode sheet rolling, thickness inspection, and rewinding and unloading.

However, the current manufacturing process for secondary batteries still suffers from the problem of poor wettability of the electrode sheet, thereby reducing the electrical performance of the secondary battery.

### SUMMARY

The present application provides a method for manufacturing a secondary battery, a secondary battery, an energy storage system, and an electric device, to improve the uniformity of electrode sheet porosity, enhance the wettability of the electrode sheet, and improve the electrical performance of the secondary battery.

To solve the technical problem that the electrical performance of the secondary battery is poor due to poor wettability of the electrode sheet, a first aspect of the present disclosure provides a method for manufacturing a secondary battery. The method includes: providing an electrode sheet, where the electrode sheet is a positive electrode sheet or a negative electrode sheet, and the electrode sheet is provided after a rolling operation; acquiring an actual porosity of the electrode sheet; determining, based on the actual porosity, whether the electrode sheet is qualified; in a case where the electrode sheet is qualified, sequentially performing rewinding, unloading, cell assembly, electrolyte filling, and packaging on the electrode sheet to form the secondary battery; and in a case where the electrode sheet is unqualified, performing laser processing on the electrode sheet to form laser-formed pores, and repeating the operations of acquiring the actual porosity of the electrode sheet and determining whether the electrode sheet is qualified based on the actual porosity, until the electrode sheet is qualified. The electrode sheet is a positive electrode sheet or a negative electrode sheet, and the electrode sheet is provided after a rolling operation.

According to a second aspect of the present disclosure, a secondary battery is provided. The secondary battery is manufactured by the method for manufacturing the secondary battery as described above.

According to a third aspect of the present disclosure, an energy storage system is provided. The energy storage system includes a plurality of secondary batteries as described above.

According to a fourth aspect of the present disclosure, an electric device is provided. The electric device includes the energy storage system as described above.

With reference to the first aspect, determining, based on the actual porosity, whether the electrode sheet is qualified includes: calculating a deviation δ₁ between the actual porosity and a target porosity, where the deviation δ₁ is calculated by formula δ₁=|δ−δ₀, where δ denotes the actual porosity and δ₀ denotes the target porosity; and determining that the electrode sheet is qualified in a case where the deviation is less than or equal to a predetermined threshold; or determining that the electrode sheet is unqualified in a case where the deviation is greater than the predetermined threshold; where the predetermined threshold is greater than 0 and less than or equal to 10%.

With reference to the first aspect, measuring the actual porosity of the electrode sheet includes: acquiring an image of the electrode sheet; measuring an area Sₜₒₜₐₗ of the electrode sheet and an area S_{solid} of a particle region within the electrode sheet based on the image; and calculating the actual porosity δ based on the area Sₜₒₜₐₗ of the electrode sheet and the area S_{solid} of the particle region, where the actual porosity δ is calculated by formula δ=1−S_{solid}/Sₜₒₜₐₗ.

With reference to the first aspect, acquiring the image of the electrode sheet includes: acquiring the image of the electrode sheet using an area-scan charge-coupled device (CCD) image sensor or a line-scan CCD image sensor, where the image is an image of a local region of the electrode sheet; and acquiring the area Sₜₒₜₐₗ of the electrode sheet and the area S_{solid} of the particle region within the electrode sheet based on the image includes: acquiring an overall area of the image as the area Sₜₒₜₐₗ of the electrode sheet, and calculating the area S_{solid} of the particle region in the image using a grayscale algorithm.

With reference to the first aspect, the laser-formed pores are circular holes; and prior to performing the laser processing on the electrode sheet to form the laser-formed pores, the method further includes: acquiring a radius r of the circular holes based on the deviation and the area of the electrode sheet, where the radius r of the circular holes is calculated by formula r=sqrt (3×δ1×Sₜₒₜₐₗ/Pi), where Pi denotes a circular ratio, and Sₜₒₜₐₗ denotes the area of the electrode sheet; and performing the laser processing on the electrode sheet to form the laser-formed pores includes: performing the laser processing on the electrode sheet based on the radius r of the circular holes to form the laser-formed pores.

With reference to the first aspect, the laser-formed pores are elongated grooves; and prior to performing the laser processing on the electrode sheet to form the laser-formed pores, the method further includes: acquiring dimensions of the elongated grooves based on the deviation and the area of the electrode sheet, where the dimensions of the elongated grooves include a length L and a width W of the elongated grooves, the length L of the elongated grooves being calculated by formula L=3×δ1×Sₜₒₜₐₗ/W, where Sₜₒₜₐₗ denotes the area of the electrode sheet, W denotes the width of the elongated grooves, and W is in a range of 0.05 μm to 0.1 μm; and performing the laser processing on the electrode sheet based on dimensions of the elongated grooves to form the laser-formed pores.

With reference to the first aspect, before performing the laser processing on the electrode sheet to form the laser-formed pores, the method further includes: acquiring a thickness of the electrode sheet, and determining parameters for the laser processing based on the thickness, where the parameters include power, pulse width, laser speed, laser temperature, and laser frequency; in response that the electrode sheet is the positive electrode sheet, the power is from 10 W to 50 W, the pulse width is from 10 ps to 100 ns, the laser speed is from 500 mm/s to 2800 mm/s, the laser temperature is from 100° C. to 300° C., and the laser frequency is from 180 kHz to 400 kHz; and in response that the electrode sheet is the negative electrode sheet, the power is from 5 W to 30 W, the pulse width is from 10 ps to 100 ns, the laser speed is from 400 mm/s to 800 mm/s, the laser temperature is from 80° C. to 200° C., and the laser frequency is from 180 kHz to 400 kHz; and performing the laser processing on the electrode sheet based on the parameters for the laser processing to form the laser-formed pores.

The technical solutions according to the present invention may achieve the following beneficial effects:

Subsequent to the rolling operation, the actual porosity of the electrode sheet is acquired, and whether the electrode sheet is qualified is determined based on the actual porosity. In a case where the electrode sheet is determined to be qualified, subsequent operations of rewinding, unloading, cell assembly, electrolyte filling, and packaging are performed on the electrode sheet to form a secondary battery. In a case where the electrode sheet is determined to be unqualified, laser processing is performed on the electrode sheet to form laser-formed pores to adjust the porosity of the electrode sheet, and the actual porosity of the electrode sheet is re-acquired and checked for qualification until the electrode sheet is qualified. Therefore, the defect of insufficient porosity in the electrode sheet is effectively identified and compensated for, the uniformity of the electrode sheet porosity is improved, and the wettability of the electrode sheet is enhanced. In this way, the ion transport performance of the electrode sheet and the electrical performance of the secondary battery are improved. Furthermore, the added process of porosity detection and adjustment in the embodiments of the present disclosure features low process cost and high safety. While improving the wettability of the electrode sheet, this process also takes into account the process cost and safety of the manufacturing of the secondary battery.

### BRIEF DESCRIPTION OF THE DRAWINGS

One or more embodiments are illustrated by way of example, and not by limitation, in the accompanying drawings, components having the same reference numeral designations represent like components throughout. The drawings are not to scale, unless otherwise disclosed.

FIG. 1 is a schematic flowchart of a method for manufacturing a secondary battery according to some embodiments of the present disclosure;

FIG. 2 is a process flowchart of manufacturing a secondary battery in the related technologies;

FIG. 3 is a process flowchart of manufacturing a secondary battery according to some embodiments of the present disclosure;

FIG. 4 is a schematic flowchart of a method for manufacturing a secondary battery according to some embodiments of the present disclosure;

FIG. 5 is a schematic flowchart of a method for manufacturing a secondary battery according to some embodiments of the present disclosure;

FIG. 6 is a process flowchart of a method for manufacturing a secondary battery according to some embodiments of the present disclosure;

FIG. 7 is a schematic flowchart of a method for manufacturing a secondary battery according to some embodiments of the present disclosure; and

FIG. 8 is a schematic flowchart of a method for manufacturing a secondary battery according to some embodiments of the present disclosure.

### DETAILED DESCRIPTION OF THE EMBODIMENTS

As known from the background, the current manufacturing process for secondary batteries still suffers from the problem of poor wettability of the electrode sheet, thereby reducing the electrical performance of the secondary battery.

During the manufacturing process of a secondary battery, in a case where fluctuations exist in both the areal density and the rolled thickness, non-uniform pore structures in local regions of the electrode sheet may be inevitably present. A non-uniform pore structure may cause local electrolyte dry-out to be prone to occur towards the end of the cycle life, and local failure may lead to a sudden plunge in the overall performance of the cell, resulting in poor wettability of the electrode sheet and thereby reducing the electrical performance of the secondary battery.

To address the poor wettability of the electrode sheet in secondary batteries, the related technologies typically improves the wettability of the electrode sheet by optimizing the electrolyte filling process and optimizing the electrolyte formula. However, this method fails to improve the local wettability of the electrode sheet, leading to poor overall wettability. Furthermore, the process cost is increased, and the safety of the secondary battery manufacturing process is affected.

To solve the technical problem, one aspect of the present disclosure provides a method for manufacturing a secondary battery. The method includes: providing an electrode sheet; measuring an actual porosity of the electrode sheet; determining whether the electrode sheet is qualified based on the actual porosity of the electrode sheet; in response to the electrode sheet being determined to qualified, forming the secondary battery using the electrode sheet; in response to the electrode sheet being determined to be unqualified, performing laser processing to form laser-formed pores on the electrode sheet, and repeating the operation of measuring the actual porosity of the electrode sheet and the operation of determining whether the electrode sheet is qualified based on the actual porosity of the electrode sheet, until the electrode sheet is qualified

Subsequent to the rolling operation, the actual porosity of the electrode sheet is acquired, and whether the electrode sheet is qualified is determined based on the actual porosity. In a case where the electrode sheet is determined to be qualified, subsequent operations of rewinding, unloading, cell assembly, electrolyte filling, and packaging are performed on the electrode sheet to form a secondary battery. In a case where the electrode sheet is determined to be unqualified, laser processing is performed on the electrode sheet to form laser-formed pores to adjust the porosity of the electrode sheet, and the actual porosity of the electrode sheet is re-acquired and checked for qualification until the electrode sheet is qualified. Therefore, the defect of insufficient porosity in the electrode sheet is effectively identified and compensated for, the uniformity of the electrode sheet porosity is improved, and the wettability of the electrode sheet is enhanced. In this way, the ion transport performance of the electrode sheet and the electrical performance of the secondary battery are improved. Furthermore, the added process of porosity detection and adjustment in the embodiments of the present disclosure features low process cost and high safety. While improving the wettability of the electrode sheet, this process also takes into account the process cost and safety of the manufacturing of the secondary battery.

For clearer descriptions of the objects, technical solutions, and advantages of the present disclosure, the embodiments of the present disclosure are described in detail with reference to accompanying drawings. However, persons of ordinary skill in the art may understand, in the embodiments of the present disclosure, more technical details are provided for readers to better understand the present disclosure. However, even though these technical details and various variations and modifications based on the embodiments hereinafter, the technical solutions of the present disclosure may also be practiced. The division of the following embodiments is for the convenience of description and should not be construed as limiting the specific implementations of the present disclosure. The various embodiments may be combined with each other without conflict.

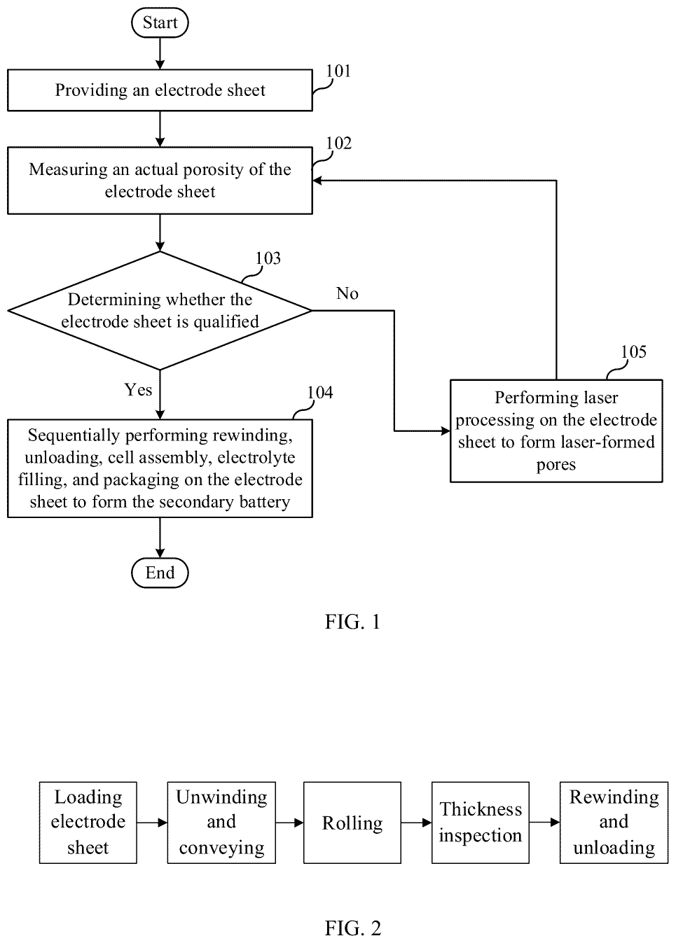

Some embodiments of the present disclosure provide a method for manufacturing a secondary battery. A schematic flowchart of the method for manufacturing the secondary battery is illustrated in FIG. 1. The method for manufacturing the secondary battery includes the following operations.

In operation 101, an electrode sheet is provided.

Specifically, the electrode sheet may be a positive electrode sheet or a negative electrode sheet, and the electrode sheet is an electrode sheet that has undergone a rolling operation.

In the manufacturing process of a secondary battery, the manufacturing of the electrode sheet is one of the key operations. As illustrated in FIG. 2, which is a process flowchart for manufacturing a secondary battery in the related technologies, the manufacturing process of an electrode sheet in the related technologies includes electrode sheet loading, unwinding and conveying, rolling of the electrode sheet, thickness inspection, and rewinding and unloading. Electrode sheet loading is to place a prepared electrode sheet or electrode roll onto a production line, which requires mounting the electrode roll onto an unwinding device to ensure that the electrode sheet can be smoothly unwound. Unwinding and conveying is to unwind the electrode roll via the unwinding device and convey the electrode sheet to a subsequent process via a conveyor belt or a roller system. During the unwinding process, the tension of the electrode sheet needs to be controlled to prevent the electrode sheet from deforming or breaking. Rolling of the electrode sheet is to compact the electrode sheet using one or more pairs of rollers, thereby compacting coating of the electrode sheet to prevent peeling during electrolyte immersion and battery use and to improve the density and mechanical strength of the electrode sheet. Thickness inspection, performed subsequent to the rolling of the electrode sheet, is to inspect the thickness of the electrode sheet to ensure that the thickness of the electrode sheet satisfies process requirements. When performing the thickness inspection on the electrode sheet, a porosity inspection is concurrently performed on the electrode sheet; that is, an image of the electrode sheet is acquired via an image sensor while the thickness inspection is performed using an optical measurement sensor, thereby improving the manufacturing efficiency of the secondary battery. Rewinding of the electrode sheet is a process where, subsequent to continuous processing of the sheet material, the sheet material is progressively wound into a large roll using a rewinding machine, thereby enabling efficient and low-loss storage and transport of the lithium-ion battery electrode sheet material. Unloading of the electrode roll, in fully automated production, involves an automated guided vehicle (AGV) automatically aligning with the unloading shaft of a receiving winder to transport the completely rewound electrode roll to a designated location.

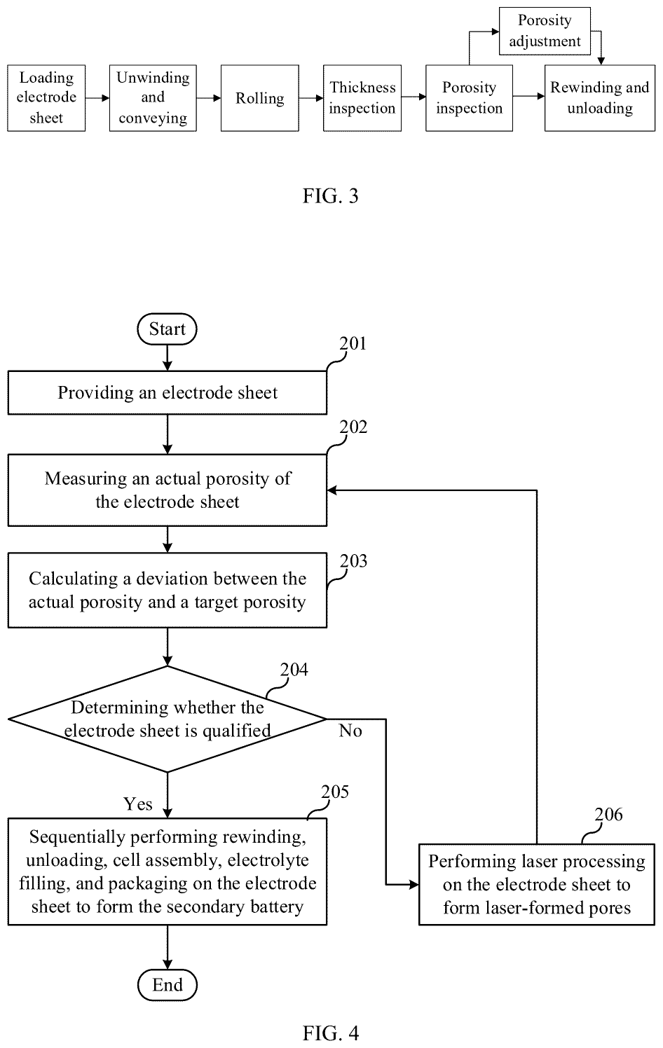

The electrode sheet is at least an electrode sheet that has undergone the rolling operation. To further improve the inspection efficiency and to prevent an electrode sheet that has failed the thickness inspection from undergoing the subsequent porosity inspection, which would reduce the overall inspection efficiency, the electrode sheet may also be an electrode sheet that has passed the thickness inspection. This improves the inspection efficiency of the electrode sheet and the manufacturing efficiency of the secondary battery. As illustrated in FIG. 3, which is a process flowchart of manufacturing a secondary battery according to some embodiments. A porosity inspection is added subsequent to the rolling and thickness inspection of the electrode sheet. In a case where the electrode sheet is qualified, the subsequent rewinding and unloading operations are performed. In a case where the electrode sheet is unqualified, a porosity adjustment is performed, such that the subsequent rewinding and unloading operations are performed only in a case where the porosity of the electrode sheet becomes qualified.

In operation 102, an actual porosity of the electrode sheet is acquired.

The actual porosity of the electrode sheet refers to the actual porosity of a local region of the electrode sheet. Since the entire surface of the electrode sheet of a secondary battery includes a plurality of local regions, in practical applications, the porosity of each of the local regions is individually acquired, such that porosity adjustment is allowed to be performed on unqualified local regions, and hence the uniformity of the electrode sheet porosity is improved. Since fluctuations in both the areal density and the rolled thickness of the electrode sheet lead to non-uniform porosity among various local regions of the electrode sheet. That is, some regions have normal porosity while others have a relatively small porosity. This in turn causes local electrolyte dry-out to be prone to occur towards the end of the cycle life of the secondary battery, and local failure may lead to a sudden plunge in the performance of the entire cell. Therefore, for each of the local regions of the electrode sheet, the corresponding actual porosity is acquired to identify the regions with abnormal porosity for subsequent porosity adjustment. This improves the uniformity of the electrode sheet porosity, enhances the wettability of the electrode sheet, and improves the performance of the manufactured secondary battery.

In operation 103, whether the electrode sheet is qualified is determined based on the actual porosity.

Subsequent to acquiring the actual porosity of a local region of the electrode sheet, whether the electrode sheet is qualified is determined based on the actual porosity. The electrode sheet is determined to be qualified in a case where the actual porosity of the electrode sheet satisfies a predetermined condition; or the electrode sheet is determined to be unqualified in a case where the actual porosity of the electrode sheet does not satisfy the predetermined condition. The predetermined condition is that a deviation between the actual porosity and a target porosity is less than or equal to a predetermined threshold.

Specifically, in a case where the electrode sheet includes a plurality of local regions, the porosity inspection is performed on each of the local regions of the electrode sheet. During the process of performing the porosity inspection on one of the local regions, the local region of the electrode sheet is determined to be qualified in a case where the actual porosity of the local region satisfies the predetermined condition; or the local region of the electrode sheet is determined to be unqualified in a case where the actual porosity of the local region does not satisfy the predetermined condition. Afterwards, the porosity inspection is performed on a next local region of the electrode sheet, and this process is repeated sequentially until the porosity inspection has been performed on all of the multiple local regions of the electrode sheet. During the process of performing the porosity inspection on each of the local regions, as long as the actual porosity corresponding to even one local region of the electrode sheet does not satisfy the predetermined condition, the problem of non-uniform porosity of the electrode sheet may arise, which affects the wettability of the electrode sheet. Therefore, it is necessary to adjust the actual porosity of the local region that does not satisfy the predetermined condition to increase the actual porosity of that local region, such that the porosity of each of the local regions of the electrode sheet is uniform and the wettability of the electrode sheet is improved.

Specifically, different processing is performed depending on whether a local region of the electrode sheet is qualified or unqualified. In a case where the local region of the electrode sheet is qualified, the process proceeds to operation 104, that is, sequentially performing rewinding, unloading, cell assembly, electrolyte filling, and packaging on the electrode sheet to form a secondary battery. In a case where the local region of the electrode sheet is unqualified, the process proceeds to operation 105, that is, performing laser processing on the electrode sheet to form laser-formed pores. Specifically, laser processing is performed on the local region of the electrode sheet to form laser-formed pores, thereby increasing the porosity of the local region, improving the uniformity of the electrode sheet porosity, and enhancing the wettability of the electrode sheet.

Specifically, in a case where the electrode sheet includes multiple local regions, the porosity inspection is performed on each of the local regions individually. In a case where the porosity of each of local regions satisfies the predetermined condition (i.e., each local region is qualified), then the process proceeds to the subsequent operation of sequentially performing rewinding, unloading, cell assembly, electrolyte filling, and packaging on the electrode sheet to form a secondary battery. In a case where the porosity of any one local region does not satisfy the predetermined condition (i.e., any one local region is unqualified), then laser processing is performed on the local region to form laser-formed pores, thereby increasing the porosity of the local region, improving the uniformity of the electrode sheet porosity, and enhancing the wettability of the electrode sheet.

In operation 104, the secondary battery is formed using the electrode sheet. In this embodiment, the operations of rewinding, unloading, cell assembly, electrolyte filling, and packaging are sequentially performed on the electrode sheet to form the secondary battery.

Specifically, in a case where the electrode sheet is qualified, subsequent operations of rewinding and unloading are performed on the electrode sheet, and afterwards, cell assembly, electrolyte filling, and packaging are performed to form the secondary battery.

Cell assembly includes stacking or winding, inserting a center pin, and packaging the cell. Stacking or winding is to alternately stack or wind a positive electrode sheet, a separator, and a negative electrode sheet into a cell according to the design of the secondary battery. The separator is configured to isolate the positive and negative electrodes to prevent short circuits. Inserting a center pin is to insert a center pin in a wound cell to fix the cell structure. Packaging the cell is to place the assembled cell into a battery casing and place insulators on both sides of the cell. Electrolyte filling is to inject electrolyte into the battery casing such that the electrolyte fully wets the cell. The electrolyte is generally composed of an electrolyte salt, a solvent, and an additive. Packaging is to seal the battery casing with a battery cap by welding or other methods to ensure hermeticity.

In operation 105, laser processing is performed on the electrode sheet to form laser-formed pores.

The laser processing is performed on the electrode sheet to form laser-formed pores; that is, laser processing is performed on a local region of the electrode sheet to form laser-formed pores, where the local region is a local region whose actual porosity does not satisfy the predetermined condition. Therefore, it is necessary to perform laser processing on the local region to increase its porosity, such that the uniformity of the overall porosity of the electrode sheet is improved and the wettability of the electrode sheet is enhanced.

The laser may be a nanosecond laser, a picosecond laser, a femtosecond laser, or the like. The laser processing is performed with the laser perpendicular to the electrode sheet to form the laser-formed pores, thereby increasing the porosity of the local region.

Subsequent to the laser processing on the electrode sheet to form the laser-formed pores, operation 102 (i.e., re-acquiring the actual porosity of the local region of the electrode sheet) and operation 103 (i.e., determining, based on the actual porosity of the local region, whether the electrode sheet is qualified) are repeated, until the electrode sheet is qualified, that is, until the local region of the electrode sheet is qualified.

Specifically, the electrode sheet is in the shape of an elongated strip, for example, having a length of 800 mm and a width of 50 mm. A local region is a partial region of the electrode sheet. For example, the electrode sheet may be divided into a plurality of local regions only along a length direction of the electrode sheet, with each local region having a length of 50 mm and a width of 50 mm. Alternatively, the electrode sheet may be divided into two equal parts along a width direction of the electrode sheet and divided into multiple local regions along a length direction of the electrode sheet, with each local region having a length of 25 mm and a width of 25 mm.

After performing porosity inspection and adjustment on each local region, laser processing is performed on a local region in a case where the porosity of the local region does not satisfy the predetermined condition as described-above, thereby increasing the porosity of that local region, improving the uniformity of porosity among the multiple local regions of the electrode sheet, and thus enhancing the wettability of the electrode sheet.

In practical applications, in a case where a situation of highly non-uniform porosity occurs, that is, some local regions have a large porosity while others have a small porosity, and the deviation between the actual porosity of a local region with large porosity and the target porosity exceeds the predetermined threshold, and the porosity of that region may not be reduced. Therefore, such an electrode sheet fails to be made into a qualified product through laser processing and may be directly screened out and scrapped.

Subsequent to the rolling operation, the actual porosity of the electrode sheet is acquired, and whether the electrode sheet is qualified is determined based on the actual porosity. In a case where the electrode sheet is determined to be qualified, subsequent operations of rewinding, unloading, cell assembly, electrolyte filling, and packaging are performed on the electrode sheet to form a secondary battery. In a case where the actual porosity of any region of the electrode sheet does not satisfy the predetermined condition and the electrode sheet is determined to be unqualified, laser processing is performed on the electrode sheet to form laser-formed pores to adjust the porosity of the electrode sheet, and the actual porosity of the electrode sheet is re-acquired and checked for qualification until the electrode sheet is qualified. Therefore, the defect of insufficient porosity in the electrode sheet is effectively identified and compensated for, the uniformity of the electrode sheet porosity is improved, and the wettability of the electrode sheet is enhanced. In this way, the ion transport performance of the electrode sheet and the electrical performance of the secondary battery are improved. Furthermore, the added process of porosity detection and adjustment in the embodiments of the present disclosure features low process cost and high safety. While improving the wettability of the electrode sheet, this process also takes into account the process cost and safety of the manufacturing of the secondary battery.

The related technologies illustrated in FIG. 2 serves as Comparative Example 1. The method for manufacturing the secondary battery, i.e., Example 1, exhibits a significant improvement in performance compared to the process in Comparative Example 1. As seen from the comparison of technical effects listed in Table 1, for the secondary battery in Comparative Example 1, the cell wetting time is 24 hours; the 0.5P cycle life-capacity retention rate is 95.7% at 500 cycles, where “95.7% at 500 cycles” indicates that after the secondary battery completes 500 full charge-discharge cycles under standard conditions, the remaining capacity is 95.7% of the initial capacity; and occasional brown spots are present on the fully charged interface of the secondary battery. In contrast, for Example 1, the cell wetting time is 16 hours, indicating a reduction of 8 hours; the 0.5P cycle life-capacity retention rate is 96.5% at 500 cycles, where “96.5% at 500 cycles” indicates that after the secondary battery completes 500 full charge-discharge cycles under standard conditions, the remaining capacity is 96.5% of the initial capacity; and no brown spots are present on the fully charged interface of the secondary battery.

It is apparent that, compared to Comparative Example 1, Example 1 exhibits improvements in the cell wetting time, the 0.5P cycle life-capacity retention rate, and the state of the fully charged interface, thereby improving the wettability of the electrode sheet and enhancing the performance of the cell.

TABLE 1

| Performance Metric | Comparative Example 1 | Example 1 |
|---|---|---|
| Cell Wetting Time | 24 h | 16 h |
| 0.5P Cycle Life - Capacity | 95.7% @ 500 | 96.5% @ 500 |
| Retention Rate | cycles | cycles |
| Fully Charged Interface | Occasional brown spots | No brown spots |

Some embodiments of the present disclosure provide a method for manufacturing a secondary battery. It is further defined that the predetermined condition is that a deviation between the actual porosity and a target porosity is less than or equal to a predetermined threshold, and further refines operation 103, i.e., determining, based on the actual porosity, whether the electrode sheet is qualified. A schematic flowchart of the method for manufacturing the secondary battery according to some embodiments is illustrated in FIG. 4. The method includes the following operations.

In operation 201, an electrode sheet is provided.

In operation 202, an actual porosity of the electrode sheet is acquired.

In operation 203, a deviation between the actual porosity and a target porosity is calculated.

Subsequent to acquisition of the actual porosity of a local region of the electrode sheet, a deviation δ₁ between the actual porosity of the local region and a target porosity is calculated. In some embodiments, the deviation &1 is calculated by formula 81=|δ−δ₀|, where δ denotes the actual porosity, and δ₀ denotes the target porosity. For example, the actual porosity δ is 35% and the target porosity is set to 40%, and then the calculated deviation δ₁ is |35%−40%|=5%.

In operation 204, whether the electrode sheet is qualified is determined based on the deviation.

Whether the electrode sheet is qualified is determined based on the deviation corresponding to a local region. That is, as long as the deviation corresponding to one local region of the electrode sheet is greater than a predetermined threshold, the problem of non-uniform porosity of the electrode sheet may arise, which affects the wettability of the electrode sheet. Therefore, it is necessary to adjust the actual porosity of the region where the deviation is greater than the predetermined threshold to increase the actual porosity of that region, such that the porosity of each local region of the electrode sheet is made uniform, and the wettability of the electrode sheet is improved.

In some embodiments, the predetermined threshold is greater than 0 and less than or equal to 10%, for example, 2%, 4%, 6%, 8%, or 10%. Specifically, the predetermined threshold may be in a range of 0 to 6%, or in a range of 0 to 4%. For example, the target porosity is set to 40% and the predetermined threshold is set to 10%; and subsequent to calculation of the actual porosity of a local region of the electrode sheet, in a case where the actual porosity of the local region is 35%, the deviation between the actual porosity of 35% and the target porosity of 40% is 5%, which is less than the predetermined threshold of 10%. In this case, the local region of the electrode sheet is determined to be qualified. In a case where the actual porosity of a local region of the electrode sheet is 25%, the deviation between the actual porosity and the target porosity of 40% is 15%, which is greater than the predetermined threshold of 10%. In this case, the local region of the electrode sheet is determined to be unqualified. Afterwards, laser processing is performed on the local region to form laser-formed pores, thereby increasing the actual porosity of the local region, such that the uniformity of the electrode sheet porosity is improved, and the wettability of the electrode sheet is enhanced.

Specifically, in a case where the electrode sheet is qualified, the process proceeds to operation 205, i.e., sequentially performing rewinding, unloading, cell assembly, electrolyte filling, and packaging on the electrode sheet to form a secondary battery. In a case where the electrode sheet is unqualified, the process proceeds to operation 206, i.e., performing laser processing on the electrode sheet to form laser-formed pores, such that the actual porosity of the local region is increased, the uniformity of the electrode sheet porosity is improved, and the wettability of the electrode sheet is enhanced.

In operation 205, rewinding, unloading, cell assembly, electrolyte filling, and packaging are sequentially performed on the electrode sheet to form the secondary battery.

In operation 206, laser processing is performed on the electrode sheet to form laser-formed pores.

Subsequent to the laser processing on the electrode sheet to form the laser-formed pores, operation 202 (i.e., acquiring the actual porosity of the electrode sheet), operation 203 (i.e., calculating the deviation between the actual porosity and the target porosity), and operation 204 (i.e., determining, based on the deviation, whether the electrode sheet is qualified) are repeated, until the electrode sheet is qualified.

Operations 201, 202, 205, and 206 are substantially the same as operations 101, 102, 104, and 105 in the above embodiment. For brevity, details are not provided herein again.

The deviation between the actual porosity of the electrode sheet and a target porosity is calculated, and whether the electrode sheet is qualified is determined based on the deviation. Thus, in a case where the electrode sheet is qualified, rewinding, unloading, cell assembly, electrolyte filling, and packaging are sequentially performed on the electrode sheet to form a secondary battery. In a case where the electrode sheet is unqualified, laser processing is performed on the electrode sheet to form laser-formed pores, such that the uniformity of the electrode sheet porosity is improved, and the wettability of the electrode sheet is enhanced.

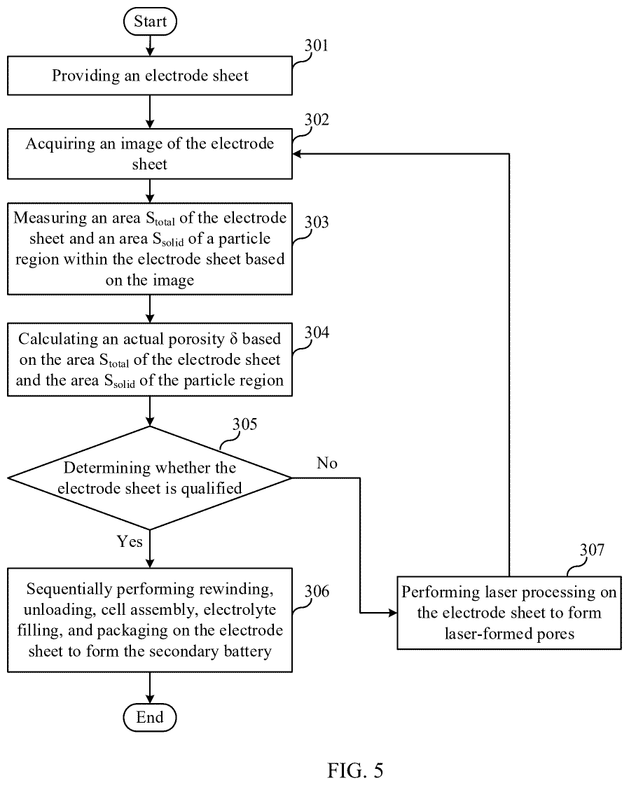

Some embodiments of the present disclosure provide a method for manufacturing a secondary battery. The method for acquiring the actual porosity of the electrode sheet is further defined. A schematic flowchart of the method for manufacturing the secondary battery is illustrated in FIG. 5. The method includes the following operations.

In operation 301, an electrode sheet is provided.

In operation 302, an image of the electrode sheet is acquired. For example, the image of the electrode sheet can be acquired using an image sensor, such as an area-scan CCD image sensor or a line-scan CCD image sensor.

In operation 303, an area Sₜₒₜₐₗ of the electrode sheet and an area S_{solid} of a particle region within the electrode sheet are acquired based on the image.

In operation 304, an actual porosity δ is acquired based on the area Sₜₒₜₐₗ of the electrode sheet and the area S_{solid} of the particle region.

Specifically, the actual porosity of a local region of the electrode sheet is acquired. To acquire the actual porosity of the local region, an image corresponding to the electrode sheet is first acquired. The image is an image of the local region of the electrode sheet. Afterwards, the area Sₜₒₜₐₗ of the local region of the electrode sheet and the area S_{solid} of the particle region within the local region are acquired based on the image. The actual porosity & corresponding to the local region is then acquired based on the area Sₜₒₜₐₗ of the local region and the area S_{solid} of the particle region. The actual porosity δ is calculated by formula δ=1−S_{solid}/Sₜₒₜₐₗ.

In some embodiments, operation 302, i.e., acquiring the image of the electrode sheet, is implemented as: acquiring the image corresponding to the local region of the electrode sheet using an area-scan CCD image sensor or a line-scan CCD image sensor.

The pixels of an area-scan CCD image sensor are arranged in a two-dimensional matrix, and the area-scan CCD image sensor is capable of capturing images of local regions of the electrode sheet simultaneously. The area-scan CCD image sensor may be a frame transfer (FT) area-scan CCD or an interline transfer (IT) area-scan CCD. The operating modes of the two are different: upon exposure, a frame transfer area-scan CCD transfers the charge accumulated in the photosensitive cells to a storage area and then reads the charge out; whereas, upon exposure, an interline transfer area-scan CCD transfers the charge from the photosensitive cells to adjacent storage cells, while the next row of photosensitive cells prepares for exposure.

The pixels of a line-scan CCD image sensor are arranged in a single line, and the line-scan CCD image sensor is capable of only capturing one row of pixels of an image at a time. A line-scan CCD image sensor captures images by means of line-by-line scanning, which features a faster image acquisition speed. The line-scan CCD image sensor may be a single-channel line-scan CCD or a dual-channel line-scan CCD. The dual-channel line-scan CCD has higher transfer efficiency, which is more conducive to increasing the image acquisition speed and improving the efficiency of the porosity inspection.

Correspondingly, operation 303, i.e., acquiring the area of the electrode sheet and the area of the particle region within the electrode sheet based on the image, is implemented as: acquiring an overall area of the image as the area Sₜₒₜₐₗ of the local region of the electrode sheet, and calculating the area S_{solid} of the particle region in that local region using a grayscale algorithm. That is, for the image of each local region of the electrode sheet, both the area Sₜₒₜₐₗ corresponding to the image and the area S_{solid} of the particle region in the image are acquired. The actual porosity δ of the local region is then calculated according to the formula for the actual porosity δ=1-S_{solid}/Sₜₒₜₐₗ.

In operation 305, whether the electrode sheet is qualified is determined based on the actual porosity.

Specifically, subsequent to acquisition of the actual porosity of a local region of the electrode sheet, a deviation between the actual porosity and a target porosity is calculated. The electrode sheet is determined to be qualified or not based on the deviation. The actual porosity of a local region where the deviation is greater than a predetermined threshold is adjusted to increase the actual porosity of that local region, thereby improving the uniformity of the electrode sheet porosity and enhancing the wettability of the electrode sheet.

Specifically, in a case where the electrode sheet is qualified, the process proceeds to operation 306, i.e., sequentially performing rewinding, unloading, cell assembly, electrolyte filling, and packaging on the electrode sheet to form a secondary battery. In a case where the electrode sheet is unqualified, the process proceeds to operation 307, i.e., performing laser processing on the electrode sheet to form laser-formed pores, such that the uniformity of the electrode sheet porosity is improved, and the wettability of the electrode sheet is enhanced.

In operation 306, rewinding, unloading, cell assembly, electrolyte filling, and packaging are sequentially performed on the electrode sheet to form the secondary battery.

In operation 307, laser processing is performed on the electrode sheet to form laser-formed pores.

Subsequent to performing the laser processing on the electrode sheet to form the laser-formed pores, the process returns to operation 302 (i.e., acquiring the image of the electrode sheet), operation 303 (i.e., acquiring the area Sₜₒₜₐₗ of the electrode sheet and the area S_{solid} of the particle region based on the image), operation 304 (i.e., acquiring the actual porosity δ based on the area Sₜₒₜₐₗ and the area S_{solid}), and operation 305 (i.e., determining, based on the actual porosity, whether the electrode sheet is qualified), until the electrode sheet is qualified.

Operations 301, 305, 306, and 307 are substantially the same as operations 101, 103, 104, and 105 in the above embodiment. For brevity, details are not provided herein again.

Some embodiments of the present disclosure provide a method for manufacturing a secondary battery. It is further defined that the laser-formed pores are circular holes. Prior to performing the laser processing on the electrode sheet to form the laser-formed pores, the method includes: acquiring a radius of the circular holes based on the deviation and the area of the electrode sheet. Performing the laser processing on the electrode sheet to form the laser-formed pores includes: performing the laser processing on the electrode sheet based on the radius r of the circular holes to form the laser-formed pores.

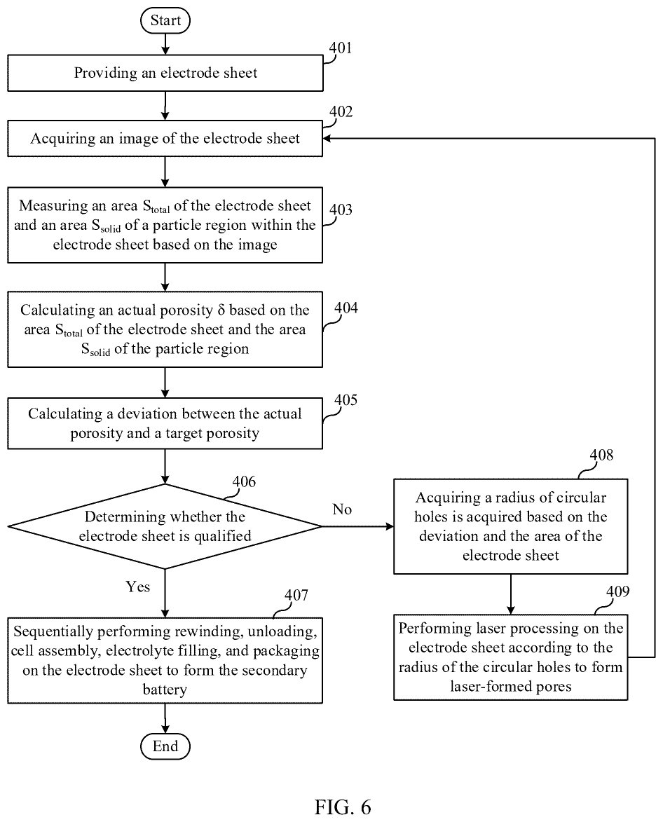

A schematic flowchart of the method for manufacturing the secondary battery according to some embodiments is illustrated in FIG. 6. The method includes the following operations.

In operation 401, an electrode sheet is provided.

In operation 402, an image of the electrode sheet is acquired.

In operation 403, an area Sₜₒₜₐₗ of the electrode sheet and an area S_{solid} of a particle region within the electrode sheet are acquired based on the image.

In operation 404, an actual porosity δ is acquired based on the area Sₜₒₜₐₗ of the electrode sheet and the area S_{solid} of the particle region.

In operation 405, a deviation between the actual porosity and a target porosity is calculated.

In operation 406, whether the electrode sheet is qualified is determined based on the deviation.

Specifically, in a case where the electrode sheet is qualified, the process proceeds to operation 407; or in a case where the electrode sheet is unqualified, the process proceeds to operation 408.

In operation 407, rewinding, unloading, cell assembly, electrolyte filling, and packaging are sequentially performed on the electrode sheet to form the secondary battery.

In operation 408, a radius of circular holes is acquired based on the deviation and the area of the electrode sheet.

In operation 409, laser processing is performed on the electrode sheet according to the radius of the circular holes to form laser-formed pores.

When the electrode sheet is determined to be unqualified, laser processing needs to be performed on a local region of the electrode sheet to form laser-formed pores. The laser processing is to increase the actual porosity of the local region, such that the deviation between the actual porosity of the local region and the target porosity becomes less than or equal to the predetermined threshold. However, different local regions have different actual porosities. In a case where the same laser processing parameters are used for all regions, the porosity of a local region with a particularly small actual porosity may not be effectively increased, such that the efficiency and accuracy of the porosity adjustment are reduced.

For further improvement of the efficiency and accuracy of the porosity adjustment, the laser-formed pores are defined as circular holes, and the radius of the circular holes is acquired based on the deviation corresponding to a local region and the area of the local region. The radius r of the circular holes is calculated by formula r=sqrt (3×δ1×Sₜₒₜₐₗ/Pi), where δ1 denotes the deviation between the actual porosity and the target porosity, Pi denotes the circular ratio (pi), and Sₜₒₜₐₗ denotes the area of the electrode sheet, i.e., the area of the local region of the electrode sheet. Afterwards, laser processing is performed on the local region of the electrode sheet based on the radius r of the circular holes to form the laser-formed pores, i.e., the circular holes. This allows for setting corresponding laser parameters according to the actual conditions of the local region, such that the porosity of the local region is adjusted, and the efficiency and accuracy of the porosity adjustment are improved.

Subsequent to the laser processing on the local region of the electrode sheet to form the laser-formed pores, the process returns to operation 402 (acquiring the image of the electrode sheet), operation 403 (acquiring the area Sₜₒₜₐₗ and the area S_{solid} of the particle region based on the image), operation 404 (acquiring the actual porosity δ based on the area Sₜₒₜₐₗ and the area S_{solid}), operation 405 (calculating the deviation between the actual porosity and the target porosity), and operation 406 (determining, based on the deviation, whether the electrode sheet is qualified), until the electrode sheet is qualified.

Operations 401 to 404 are substantially the same as operations 301 to 304 in the above embodiment, and operations 405 to 407 are substantially the same as operations 203 to 205 in the above embodiment. For brevity, details are not provided herein again.

By defining the laser-formed pores as circular holes, acquiring the radius of the circular holes based on the deviation corresponding to a local region and the area of the local region, and performing laser processing on the local region of the electrode sheet based on the radius, corresponding laser parameters are set according to the actual conditions of the local region, such that the porosity of the local region is adjusted, and the efficiency and accuracy of the porosity adjustment are improved.

The method for optimizing the electrolyte filling process and the electrolyte formula in the related technologies serves as Comparative Example 2. As seen from the comparison of technical effects listed in Table 2, for the secondary battery in Comparative Example 2, the cell wetting time is 20 hours; the 0.5P cycle life-capacity retention rate is 95.8% at 500 cycles, where “95.8% at 500 cycles” indicates that after the secondary battery completes 500 full charge-discharge cycles under standard conditions, the remaining capacity is 95.8% of the initial capacity; and the fully charged interface is uniform with no brown spots. In contrast, for the secondary battery in Example 2, the cell wetting time is 16 hours; the 0.5P cycle life-capacity retention rate is 96.5% at 500 cycles, where “96.5% at 500 cycles” indicates that in a case where the secondary battery completes 500 full charge-discharge cycles under standard conditions, the remaining capacity is 96.5% of the initial capacity; and the fully charged interface is uniform with no brown spots.

It is apparent that, compared to Comparative Example 2, Example 2 exhibits no significant change in the fully charged interface, but the cell wetting time is significantly reduced, and the 0.5P cycle life-capacity retention rate is also improved, thereby improving the wettability of the electrode sheet and enhancing the performance of the cell.

TABLE 2

| | Comparative | |
|---|---|---|
| Performance Metric | Example 2 | Example 2 |
| Cell Wetting Time | 20 h | 16 h |
| 0.5P Cycle Life - | 95.8% @, 500 | 96.5% @, 500 |
| Capacity Retention Rate | cycles | cycles |
| Fully Charged Interface | Uniform interface, | Uniform interface, |
| | no brown spots | no brown spots |

Some embodiments of the present disclosure provide a method for manufacturing a secondary battery. It is further defined that the laser-formed pores are elongated grooves. Prior to performing the laser processing on the electrode sheet to form the laser-formed pores, the method includes: acquiring dimensions of the elongated grooves based on the deviation and the area of the electrode sheet. Performing the laser processing on the electrode sheet to form the laser-formed pores includes: performing the laser processing on the electrode sheet according to the dimensions of the elongated grooves to form the laser-formed pores.

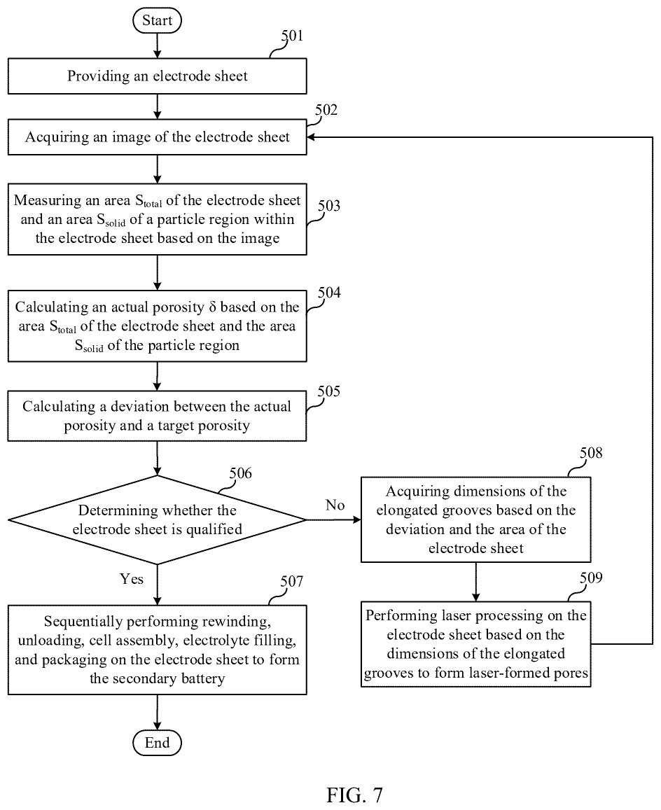

A schematic flowchart of the method for manufacturing the secondary battery according to some embodiments is illustrated in FIG. 7. The method includes the following operations.

In operation 501, an electrode sheet is provided.

In operation 502, an image of the electrode sheet is acquired.

In operation 503, an area Sₜₒₜₐₗ of the electrode sheet and an area S_{solid} of a particle region within the electrode sheet are acquired based on the image.

In operation 504, an actual porosity δ is acquired based on the area Sₜₒₜₐₗ of the electrode sheet and the area S_{solid} of the particle region.

In operation 505, a deviation between the actual porosity and a target porosity is calculated.

In operation 506, whether the electrode sheet is qualified is determined based on the deviation.

In a case where the electrode sheet is qualified, the process proceeds to operation 507; or in a case where the electrode sheet is unqualified, the process proceeds to operation 508.

In operation 507, rewinding, unloading, cell assembly, electrolyte filling, and packaging are sequentially performed on the electrode sheet to form the secondary battery.

In operation 508, dimensions of the elongated grooves are acquired based on the deviation and the area of the electrode sheet.

In operation 509, laser processing is performed on the electrode sheet based on the dimensions of the elongated grooves to form laser-formed pores.

When the electrode sheet is determined to be unqualified, laser processing needs to be performed on a local region of the electrode sheet to form laser-formed pores. The laser processing is to increase the actual porosity of the local region, such that the deviation between the actual porosity of the local region and the target porosity becomes less than or equal to the predetermined threshold. However, different local regions have different actual porosities. In a case where the same laser processing parameters are used for all regions, the porosity of a local region with a particularly small actual porosity may not be effectively increased, such that the efficiency and accuracy of the porosity adjustment are reduced.

For further improvement of the efficiency and accuracy of the porosity adjustment, the laser-formed pores are defined as elongated grooves, and the dimensions of the elongated grooves are acquired based on the deviation corresponding to a local region and the area of the local region.

The dimensions of the elongated grooves include a length and a width of the elongated grooves. The length L of the elongated grooves is calculated by formula L=3×δ1×Sₜₒₜₐₗ/W, where δ1 denotes the deviation between the actual porosity and the target porosity, Sₜₒₜₐₗ denotes the area of the electrode sheet, i.e., the area of the local region of the electrode sheet, and W denotes the width of the elongated grooves. W is a fixed value in a range of 0.05 μm to 0.1 μm, for example, 0.05 μm, 0.06 μm, 0.07 μm, 0.08 μm, 0.09 μm, or 0.1 μm.

Afterwards, laser processing is performed on the local region of the electrode sheet based on the dimensions of the elongated grooves to form the laser-formed pores, i.e., the elongated grooves. This allows for setting corresponding laser parameters according to the actual conditions of the local region, such that the porosity of the local region is adjusted, and the efficiency and accuracy of the porosity adjustment are improved.

Subsequent to the laser processing on the electrode sheet to form the laser-formed pores, the process returns to operation 502 (acquiring the image of the electrode sheet), operation 503 (acquiring the area Sₜₒₜₐₗ and the area S_{solid} of the particle region based on the image), operation 504 (acquiring the actual porosity δ based on the area Sₜₒₜₐₗ and the area S_{solid}), operation 505 (calculating the deviation between the actual porosity and the target porosity), and operation 506 (determining, based on the deviation, whether the electrode sheet is qualified), until the electrode sheet is qualified.

Operations 501 to 507 are substantially the same as operations 401 to 407 in the above embodiment. For brevity, details are not provided herein again.

By defining the laser-formed pores as elongated grooves, acquiring the dimensions of the elongated grooves based on the deviation corresponding to a local region and the area of the local region, and performing laser processing on the local region of the electrode sheet according to the dimensions of the elongated grooves, corresponding laser parameters are set according to the actual conditions of the local region, such that the porosity of the local region is adjusted, and the efficiency and accuracy of the porosity adjustment are improved.

The method for optimizing the electrolyte filling process and the electrolyte formula in the related technologies serves as Comparative Example 2. As seen from the comparison of technical effects listed in Table 3, for the secondary battery in Comparative Example 2, the cell wetting time is 20 hours; the 0.5P cycle life-capacity retention rate is 95.8% at 500 cycles, where “95.8% at 500 cycles” indicates that after the secondary battery completes 500 full charge-discharge cycles under standard conditions, the remaining capacity is 95.8% of the initial capacity; and the fully charged interface is uniform with no brown spots. In contrast, for the secondary battery in Example 3, the cell wetting time is 16 hours; the 0.5P cycle life-capacity retention rate is 96.4% at 500 cycles, where “96.4% at 500 cycles” indicates that in a case where the secondary battery completes 500 full charge-discharge cycles under standard conditions, the remaining capacity is 96.4% of the initial capacity; and the fully charged interface is uniform with no brown spots.

It is apparent that, compared to Comparative Example 2, Example 3 exhibits no significant change in the fully charged interface, but the cell wetting time is significantly reduced, and the 0.5P cycle life-capacity retention rate is also improved, thereby improving the wettability of the electrode sheet and enhancing the performance of the cell.

TABLE 3

| | Comparative | |
|---|---|---|
| Performance Metric | Example 2 | Example 3 |
| Cell Wetting Time | 20 h | 16 h |
| 0.5P Cycle Life - | 95.8% @, 500 | 96.4% @ 500 cycles |
| Capacity Retention Rate | cycles | |
| Fully Charged Interface | Uniform interface, | Uniform interface, |
| | no brown spots | no brown spots |

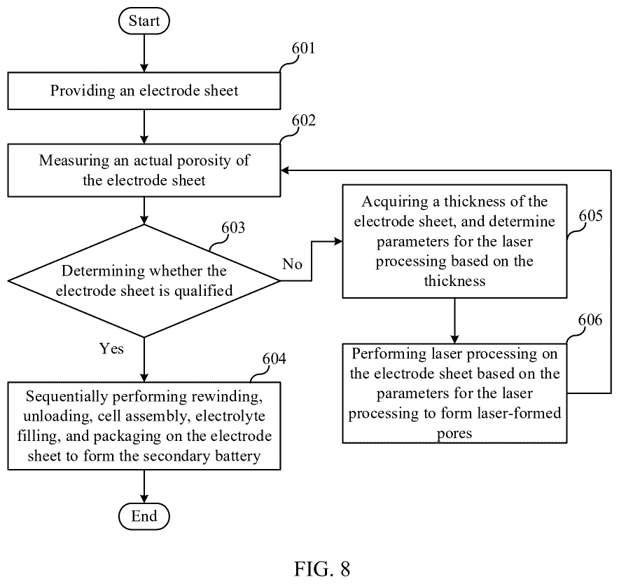

Some embodiments of the present disclosure provide a method for manufacturing a secondary battery. It is further defined that prior to performing the laser processing on the electrode sheet to form the laser-formed pores, a thickness of the electrode sheet is acquired, and parameters for the laser processing are determined based on the thickness. A schematic flowchart of the method for manufacturing the secondary battery according to some embodiments is illustrated in FIG. 8. The method includes the following operations:

In operation 601, an electrode sheet is provided.

In operation 602, an actual porosity of the electrode sheet is acquired.

In operation 603, whether the electrode sheet is qualified is determined based on the actual porosity.

In operation 604, rewinding, unloading, cell assembly, electrolyte filling, and packaging are sequentially performed on the electrode sheet to form the secondary battery.

In operation 605, a thickness of the electrode sheet is acquired, and parameters for the laser processing are determined based on the thickness.

The parameters for the laser processing include power, pulse width, laser speed, laser temperature, and laser frequency.

In a case where the electrode sheet is the positive electrode sheet, the power is from 10 W to 50 W, for example, 10 W, 20 W, 30 W, 40 W, or 50 W; the pulse width is from 10 ps to 100 ns, for example, 10 ps, 20 ps, 30 ps, 40 ps, 50 ps, 60 ps, 70 ps, 80 ps, 90 ps, or 100 ps; the laser speed is from 500 mm/s to 2800 mm/s, for example, 500 mm/s, 800 mm/s, 1000 mm/s, 1500 mm/s, 2000 mm/s, 2500 mm/s, or 2800 mm/s; the laseinto

r temperature is from 100° C. to 300° C., for example, 100° C., 150° C., 200° C., 250° C., or 300° C.; and the laser frequency is from 180 kHz to 400 kHz, for example, 180 kHz, 200 kHz, 250 kHz, 300 kHz, 350 kHz, or 400 kHz.

In a case where the electrode sheet is the negative electrode sheet, the power is from 5 W to 30 W, for example, 5 W, 15 W, 20 W, 25 W, or 30 W; the pulse width is from 10 ps to 100 ns, for example, 10 ps, 20 ps, 30 ps, 40 ps, 50 ps, 60 ps, 70 ps, 80 ps, 90 ps, or 100 ps; the laser speed is from 400 mm/s to 800 mm/s, for example, 400 mm/s, 500 mm/s, 600 mm/s, 700 mm/s, or 800 mm/s; the laser temperature is from 80° C. to 200° C., for example, 80° C., 100° C., 120° C., 140° C., 160° C., 180° C., or 200° C.; and the laser frequency is from 180 kHz to 400 kHz, for example, 180 kHz, 200 kHz, 250 kHz, 300 kHz, 350 kHz, or 400 kHz.

The thickness of the electrode sheet may be directly acquired from the thickness recorded during the thickness inspection process, such that the efficiency of the laser processing and the efficiency of the porosity adjustment are improved.

In operation 606, laser processing is performed on the electrode sheet based on the parameters for the laser processing to form laser-formed pores.

For electrode sheets of different thicknesses, in a case where the same laser processing parameters are used for all, there is a risk of reduced laser processing efficiency, and the porosity may not be effectively adjusted. Therefore, the parameters for the laser processing, including power, pulse width, laser speed, and laser temperature, are determined based on the thickness of the electrode sheet, and the laser processing is performed on the electrode sheet based on the parameters to form the laser-formed pores, such that improving the efficiency of the laser processing and the accuracy of the porosity adjustment are improved.

Subsequent to the laser processing on the electrode sheet to form the laser-formed pores, the process returns to operation 602 and operation 603, until the electrode sheet is qualified.

Operations 601 to 604 are substantially the same as operations 101 to 104 in the above embodiment. For brevity, details are not provided herein again.

Another aspect of the present disclosure provides a secondary battery. The secondary battery is manufactured by the method for manufacturing the secondary battery according to the above embodiments.

The secondary battery is manufactured by the method for manufacturing the secondary battery according to the above embodiments. The secondary battery is one that has undergone and passed the porosity inspection. In this way, the wettability of the electrode sheet in the secondary battery is improved, such that the ion transport performance of the electrode sheet and the electrical performance of the secondary battery are enhanced.

Specifically, the electrode sheet of the secondary battery has undergone electrode sheet loading, unwinding and conveying, rolling, thickness inspection, porosity inspection, and rewinding and unloading. In a case where the rewinding and unloading of the electrode sheet are completed, subsequent operations of cell assembly, electrolyte filling, and packaging are performed to form the secondary battery.

Yet another aspect of the present disclosure provides an energy storage system. The energy storage system includes a plurality of the secondary batteries according to the above embodiments.

The energy storage system includes a plurality of the secondary batteries according to the above embodiments. The secondary batteries have undergone and passed the porosity inspection. In this way, the wettability of the electrode sheets in the secondary batteries is improved, such that the electrical performance of the secondary batteries and the performance of the energy storage system are enhanced.

Specifically, in a case where the packaging of the secondary batteries is completed, operations such as cell stacking, tab processing, module packaging, system assembly, and energy storage system integration are sequentially performed on the secondary batteries to form the energy storage system. The energy storage system may be applied in various scenarios, including power storage, grid peak shaving, and renewable energy support.

Still another aspect of the present disclosure provides an electric device. The electric device includes the energy storage system according to the above embodiments.

The electric device includes the energy storage system according to the above embodiments. The secondary batteries in the energy storage system have undergone and passed the porosity inspection, and have high electrical performance, such that the performance of the electric device is improved.

The electric device may be a portable terminal, a pure electric vehicle, a hybrid electric vehicle, an electric ship, a smart home appliance, or the like.

Persons of ordinary skill in the art shall understand that the above embodiments are merely specific and exemplary embodiments for practicing the present disclosure, and in practice, various modifications may be made to these embodiments in terms of formality and detail, without departing from the spirit and scope of the present invention.

What is claimed is:

1. A method for manufacturing a secondary battery, the method comprising:
providing an electrode sheet;
measuring an actual porosity of the electrode sheet;
determining whether the electrode sheet is qualified based on the actual porosity of the electrode sheet;
in response to the electrode sheet being determined to qualified, forming the secondary battery using the electrode sheet;
in response to the electrode sheet being determined to be unqualified, performing laser processing to form laser-formed pores on the electrode sheet, and repeating the operation of measuring the actual porosity of the electrode sheet and the operation of determining whether the electrode sheet is qualified based on the actual porosity of the electrode sheet, until the electrode sheet is qualified.

2. The method according to claim 1, wherein determining whether the electrode sheet is qualified based on the actual porosity of the electrode sheet, includes:
calculating a deviation δ₁ between the actual porosity and a target porosity, wherein the deviation δ₁ is calculated by formula δ1=|δ−δ₀|, wherein δ₀ denotes the actual porosity, and δ₀ denotes the target porosity; and
determining that the electrode sheet is qualified in response to the deviation being less than or equal to a predetermined threshold, or determining that the electrode sheet is unqualified in response to the deviation being greater than the predetermined threshold;
wherein the predetermined threshold is greater than 0 and less than or equal to 10%.

3. The method according to claim 2, wherein measuring the actual porosity of the electrode sheet includes:
acquiring an image of the electrode sheet;
measuring an area Sₜₒₜₐₗ of the electrode sheet and an area S_{solid} of a particle region within the electrode sheet based on the image; and
calculating the actual porosity δ based on the area Sₜₒₜₐₗ of the electrode sheet and the area S_{solid} of the particle region, wherein the actual porosity δ is calculated by formula δ=1−S_{solid}/Sₜₒₜₐₗ.

4. The method according to claim 3, wherein acquiring the image of the electrode sheet includes:
acquiring the image of the electrode sheet using an area-scan CCD image sensor or a line-scan CCD image sensor, wherein the image is an image of a local region of the electrode sheet; and
acquiring the area Sₜₒₜₐₗ of the electrode sheet and the area S_{solid} of the particle region within the electrode sheet based on the image includes:
acquiring an overall area of the image as the area Sₜₒₜₐₗ of the electrode sheet, and calculating the area S_{solid} of the particle region in the image using a grayscale algorithm.

5. The method according to claim 3, wherein the laser-formed pores are circular holes;
and wherein before performing the laser processing on the electrode sheet to form the laser-formed pores, the method further includes:
acquiring a radius r of the circular holes based on the deviation and the area of the electrode sheet, wherein the radius r of the circular holes is calculated by formula r=sqrt (3×δ₁×Sₜₒₜₐₗ/Pi), wherein Pi denotes a circular ratio, and Sₜₒₜₐₗ denotes the area of the electrode sheet; and
performing the laser processing on the electrode sheet based on the radius of the circular holes to form the laser-formed pores.

6. The method according to claim 3, wherein the laser-formed pores are elongated grooves;
and wherein before performing the laser processing on the electrode sheet to form the laser-formed pores, the method further includes:
acquiring dimensions of the elongated grooves based on the deviation and the area of the electrode sheet, wherein the dimensions of the elongated grooves include a length L and a width W of the elongated grooves, the length L of the elongated grooves being calculated by formula L=3×δ₁×Sₜₒₜₐₗ/W, wherein Sₜₒₜₐₗ denotes the area of the electrode sheet, W denotes the width of the elongated grooves, and W is in a range of 0.05 μm to 0.1 μm; and
performing the laser processing on the electrode sheet based on dimensions of the elongated grooves to form the laser-formed pores.

7. The method according to claim 1, wherein the electrode sheet is a positive electrode sheet or a negative electrode sheet, and the electrode sheet is provided after a rolling operation.

8. The method according to claim 7, wherein before performing the laser processing on the electrode sheet to form the laser-formed pores, the method further includes:
acquiring a thickness of the electrode sheet, and determining parameters for the laser processing based on the thickness, wherein the parameters include power, pulse width, laser speed, laser temperature, and laser frequency;
in response that the electrode sheet is the positive electrode sheet, the power is from 10 W to 50 W, the pulse width is from 10 ps to 100 ns, the laser speed is from 500 mm/s to 2800 mm/s, the laser temperature is from 100° C. to 300° C., and the laser frequency is from 180 kHz to 400 kHz; and in response that the electrode sheet is the negative electrode sheet, the power is from 5 W to 30 W, the pulse width is from 10 ps to 100 ns, the laser speed is from 400 mm/s to 800 mm/s, the laser temperature is from 80° C. to 200° C., and the laser frequency is from 180 kHz to 400 kHz; and
performing the laser processing on the electrode sheet based on the parameters for the laser processing to form the laser-formed pores.

9. A secondary battery, wherein the secondary battery is manufactured using a method for manufacturing a secondary battery, and the method comprising:
providing an electrode sheet;
measuring an actual porosity of the electrode sheet;
determining whether the electrode sheet is qualified based on the actual porosity of the electrode sheet;
in response to the electrode sheet being determined to qualified, forming the secondary battery using the electrode sheet;
in response to the electrode sheet being determined to be unqualified, performing laser processing to form laser-formed pores on the electrode sheet, and repeating the operation of measuring the actual porosity of the electrode sheet and the operation of determining whether the electrode sheet is qualified based on the actual porosity of the electrode sheet, until the electrode sheet is qualified.

10. The secondary battery according to claim 9, wherein determining whether the electrode sheet is qualified the actual porosity of the electrode sheet, includes:
calculating a deviation δ₁ between the actual porosity and a target porosity, wherein the deviation δ₁ is calculated by formula δ1=|δ−δ₀|, wherein δ₀ denotes the actual porosity, and do denotes the target porosity; and
determining that the electrode sheet is qualified in response to the deviation being less than or equal to a predetermined threshold, or determining that the electrode sheet is unqualified in response to the deviation being greater than the predetermined threshold;
wherein the predetermined threshold is greater than 0 and less than or equal to 10%.

11. The secondary battery according to claim 10, wherein measuring the actual porosity of the electrode sheet includes:
acquiring an image of the electrode sheet;
measuring an area Sₜₒₜₐₗ of the electrode sheet and an area S_{solid} of a particle region within the electrode sheet based on the image; and
calculating the actual porosity δ based on the area Sₜₒₜₐₗ of the electrode sheet and the area S_{solid} of the particle region, wherein the actual porosity δ is calculated by formula δ=1−S_{solid}/Sₜₒₜₐₗ.

12. The secondary battery according to claim 11, wherein acquiring the image of the electrode sheet includes:
acquiring the image of the electrode sheet using an area-scan CCD image sensor or a line-scan CCD image sensor, wherein the image is an image of a local region of the electrode sheet; and
acquiring the area Sₜₒₜₐₗ of the electrode sheet and the area S_{solid} of the particle region within the electrode sheet based on the image includes:
acquiring an overall area of the image as the area Sₜₒₜₐₗ of the electrode sheet, and calculating the area S_{solid} of the particle region in the image using a grayscale algorithm.

13. The secondary battery according to claim 12, wherein the laser-formed pores are circular holes; and wherein before performing the laser processing on the electrode sheet to form the laser-formed pores, the method further includes:
acquiring a radius r of the circular holes based on the deviation and the area of the electrode sheet, wherein the radius r of the circular holes is calculated by formula r=sqrt (3×δ₁×Sₜₒₜₐₗ/Pi), wherein Pi denotes a circular ratio, and Sₜₒₜₐₗ denotes the area of the electrode sheet; and
performing the laser processing on the electrode sheet based on the radius of the circular holes to form the laser-formed pores.

14. The secondary battery according to claim 12, wherein the laser-formed pores are elongated grooves; and wherein before performing the laser processing on the electrode sheet to form the laser-formed pores, the method further includes:
acquiring dimensions of the elongated grooves based on the deviation and the area of the electrode sheet, wherein the dimensions of the elongated grooves include a length L and a width W of the elongated grooves, the length L of the elongated grooves being calculated by formula L=3×δ₁×Sₜₒₜₐₗ/W, wherein Sₜₒₜₐₗ denotes the area of the electrode sheet, W denotes the width of the elongated grooves, and W is in a range of 0.05 μm to 0.1 μm; and
performing the laser processing on the electrode sheet based on dimensions of the elongated grooves to form the laser-formed pores.

15. The secondary battery according to claim 9, wherein the electrode sheet is a positive electrode sheet or a negative electrode sheet, and the electrode sheet is provided after a rolling operation.

16. The secondary battery according to claim 15, wherein before performing the laser processing on the electrode sheet to form the laser-formed pores, the method further includes:
acquiring a thickness of the electrode sheet, and determining parameters for the laser processing based on the thickness, wherein the parameters include power, pulse width, laser speed, laser temperature, and laser frequency;
in response that the electrode sheet is the positive electrode sheet, the power is from 10 W to 50 W, the pulse width is from 10 ps to 100 ns, the laser speed is from 500 mm/s to 2800 mm/s, the laser temperature is from 100° C. to 300° C., and the laser frequency is from 180 kHz to 400 kHz; and in response that the electrode sheet is the negative electrode sheet, the power is from 5 W to 30 W, the pulse width is from 10 ps to 100 ns, the laser speed is from 400 mm/s to 800 mm/s, the laser temperature is from 80° C. to 200° C., and the laser frequency is from 180 kHz to 400 kHz; and
performing the laser processing on the electrode sheet based on the parameters for the laser processing to form the laser-formed pores.

17. An energy storage system, comprising a plurality of secondary batteries, wherein each secondary battery of the plurality of secondary batteries is manufactured using a method for manufacturing a secondary battery, and the method includes:
providing an electrode sheet;
measuring an actual porosity of the electrode sheet;
determining whether the electrode sheet is qualified based on the actual porosity of the electrode sheet;
in response to the electrode sheet being determined to qualified, forming the secondary battery using the electrode sheet;
in response to the electrode sheet being determined to be unqualified, performing laser processing to form laser-formed pores on the electrode sheet, and repeating the operation of measuring the actual porosity of the electrode sheet and the operation of determining whether the electrode sheet is qualified based on the actual porosity of the electrode sheet, until the electrode sheet is qualified.

18. The energy storage system according to claim 12, wherein the electrode sheet is a positive electrode sheet or a negative electrode sheet, and the electrode sheet is provided after a rolling operation.

19. An electric device, comprising an energy storage system, wherein the energy storage system includes a plurality of secondary batteries, each secondary battery of the plurality of secondary batteries is manufactured using a method for manufacturing a secondary battery, and the method includes:
providing an electrode sheet;
measuring an actual porosity of the electrode sheet;
determining whether the electrode sheet is qualified based on the actual porosity of the electrode sheet;
in response to the electrode sheet being determined to qualified, forming the secondary battery using the electrode sheet;
in response to the electrode sheet being determined to be unqualified, performing laser processing to form laser-formed pores on the electrode sheet, and repeating the operation of measuring the actual porosity of the electrode sheet and the operation of determining whether the electrode sheet is qualified based on the actual porosity of the electrode sheet, until the electrode sheet is qualified.

20. The electric device according to claim 19, wherein the electrode sheet is a positive electrode sheet or a negative electrode sheet, and the electrode sheet is provided after a rolling operation.
